(19) United States
(12) Patent Application Publication
(10) Pub. No.: US 2004/0078783 A1
(43) Pub. Date: Apr. 22, 2004

(54) Tool and system for software verification support

(75) Inventor: Takeshi Matsushima, Matsuyama-Shi (JP)

Correspondence Address: Richard P. Berg, Esq., c/o LADAS & PARRY, Suite 2100, 5670 Wilshire Boulevard, Los Angeles, CA, 90036-5679, US

(73) Assignee: IYO ENGINEERING CO., LTD.

(21) Appl. No.: 10/409,919

(22) Filed: Apr. 8, 2003

(30) Foreign Application Priority Data
Oct. 21, 2002 (JP) 2002-305445
Dec. 11, 2002 (JP) 2002-358846

(51) Int. Cl. G06F 9/44; G06F 9/445

(52) U.S. Cl. 717/126; 717/103; 717/174

(57) ABSTRACT

There is provided a tool for software verification support which can collectively collect information effective for verification of software operations such as understanding of operating environments of software, following up of a fault cause, verification of normal operations by one-touch operation or by a command from a program. The tool comprises: system information acquisition means which is started by an instruction of a user or by a command from a program, and acquires information in a hard copy of a display screen displayed at least at the starting time as system information of a relevant computer necessary for verification of software operations, and describes computer information related with software operations including software operating environments at the starting time in a text format for acquisition; system information preservation means which preserves the acquired system information in a piece of recording media which the computer can read; system information output means which outputs the acquired system information in a predetermined format which the computer and the relevant user can recognize.

### BACKGROUND OF THE INVENTION

1. Field of the Invention

The present invention relates to a tool and a system for software verification support, having a function by which system information, which is mainly used for verification of software operations, including understanding of operating environments of software which is operated on a computer, following-up of the causes of faults, and verification of normal operations, is collected, recorded, and output in a predetermined format which the computer and a relevant user can recognize.

2. Description of the Related Art

Software which is operated on a computer is roughly divided into the following two classes: “system software” comprising basic software such as OS (operating system) and middleware; and “applied software” which is called application software. Here, assuming that applied software which a general user directly uses is a subject, a conventional method dealing with a fault, which is generated in the applied software, will be explained.

Conventionally, when some faults are caused in a piece of applied software which a general user has purchased, and failures which the user can not control by himself/herself occur, the faults have been generally dealt with by complex processes, for example, the fault status is notified by telephone or facsimile to a support center of a manufacturer which has provided the applied software, and a method for dealing with the fault is obtained from a person in charge at the side of the support center. As a method for conveying a fault status, other than an oral method, for example, a method by which necessary items, such as a hardware configuration and a fault status, in a fault diagnosis table which has been prepared by the side of a support center, are filled in, and the fault diagnosis table is sent to the support center by facsimile and the like in order to ask for repairing, has been well-known (for example, refer to a non-patent document 1: “disclosed contents in a VAIO customer link on a website of Sony Corporation: Procedure 3 in an explanation of “A Rule for No-Charge Repairing”, and Description in “VAIO Case Record”, [Retrieved on Oct. 15, 2002], the Internet <URL:http://vcl.vaio.sony.co.jp/repair2/>”).

Moreover, methods by which an electronic mail is used for conveying information necessary for fault analysis are disclosed in a patent document 1 (Japanese Unexamined Patent Application Publication NO. 2002-197170), and in a patent document 2 (Japanese Unexamined Patent Application Publication NO. 2001-5692). The patent document 1 has disclosed the following point, Detailed information on inquiries and faults from a user (contents of inquiries, which the user has described, and the like) is received by the side of a support center as an electronic mail, and it is determined by an identifier (presence of a circle mark) in the detailed information whether the information is related with a hardware fault or with a software fault. In the case of the hardware fault, a diagnosis program is transmitted to a user computer and is executed, and a fault location is specified by the execution result and the fault cases. In the case of a software fault, it is determined by checking of the version of the function of the software whether the latest patch information is reflected or not, and if not reflected, the function of the latest version is transmitted to the user computer, and the function of the software of the user computer is changed into the latest version one.

And, the patent document 2 has described the following point. In a computer system, when a hardware fault is detected by an error detection circuit, or when a software fault is detected by a piece of monitoring software, basic information necessary for fault analysis (hardware fault information such as temperature, voltages at each part, memory faults, and log information such as a history of operating environments of an operating system) is collected, and a file made from the collected information is attached to an electronic mail, and transmitted to a maintenance management system (a computer as a maintenance window). The side of the maintenance management service system analyzes the attachment file to determine whether an fault event is an OS fault, an application fault, or a hardware fault, and classifies and notifies the above electronic mail to a maintenance management site (a computer in charge of analysis of the relevant fault) corresponding to the kind of the fault.

[Non-Patent Document 1]

Disclosed contents in a VAIO customer link on a website of Sony Corporation: Procedure 3 in an explanation of “A Rule for No-Charge Repairing”, and Description in “VAIO Case Record”, [Retrieved on Oct. 15, 2002], the Internet <URL:http://vcl.vaio.sony.co.jp/repair2/>″).

[Patent Document 1]

Japanese Unexamined Patent Application Publication NO. 2002-197170

[Patent Document 2]

Japanese Unexamined Patent Application Publication NO. 2001-5692

### SUMMARY OF THE INVENTION

Here, faults in application software have occurred by various kinds of causes, other than by bugs in application software itself, for example, by hardware faults, by bugs in basic software, and by operating environments (insufficient resources in storage media and the like). In order to follow up the causes of the faults, detailed information on operating environments, statuses when the faults occur, and the like has been required in many cases. However, it is very difficult for general users to convey the above information to the sides of support centers in an exact manner. For example, as described in the above-described non-patent document 1 and patent document 1, it is troublesome for the users themselves to fill in necessary items such as fault states and kinds of the faults, and convey them by facsimile or by electronic mail. Moreover, it is further difficult for users with no experience to fill in the necessary items. Furthermore, according to present situation, the causes of the faults have not been located, in many cases, only by information which the users have described. Also, there has also been a problem that, since necessary information when the faults occurred are lost while various kinds of operations are executed in order to obtain the detailed information, it becomes impossible to follow up the causes of the faults. As described above, it is difficult not only for general users, but also for a staff in charge of computer management and a software developer to extract effective information from various kinds of information.

On the other hand, the method described in the patent document 2 is convenient in automatic collection of information, as, when hardware faults or software faults are detected, hardware fault information and a history (log information) of operating environments of an operating system are configured to be collected in an automatic manner into a file, which is automatically attached to an electronic mail for transmission. However, fault detection means to detect faults is a mandatory system component, and it is considered to be difficult to apply the method to a general-purpose computer. Also, it is required as a prerequisite to automatically classify faults in order to automatically classify and notify electronic mails according to the kinds of faults (each fault in hardware, an OS, and application software according to the example in the patent document 2). The method described in the patent document 2 can classify faults as faults to be dealt with by the method are ones which can be detected by the fault detection means, but, with regard to faults generated on a computer, there are many cases in which it is difficult to detect faults, or it is impossible to specify the kinds of the faults. Thereby, there has been a problem that the method may not be applicable to the above kinds of faults.

Also, since information to be collected is temperature, voltages at each part, information on hardware faults such as memory faults, a history of operating environments of an operating system in the method described in the patent document 2, only an expert staff in charge can diagnose the above information. Though the method described in the patent document 2 is seemed to be effective for comparatively large-scale computer systems such as large-scale computers which are introduced in enterprises, it is thought that the method is not appropriate for general-purpose computers which general users use.

Here, operating environments of pieces of recent software which are operating on general-purpose computers depend various kinds of things. For example, when Windows which is an OS by Microsoft USA Corporation is given as one example, there are an enormous number of combinations even only with regard to static operating environments, considering combinations between the kinds of software and those of hardware, for example, combinations between the kinds of Windows, service packing, versions of Internet Explorer, versions of various kinds of system files, and hardware environments. Thereby, it often happens that, though it is confirmed that a piece of software normally operates in a computer which the software has been developed, the software does not normally operate in other personal computers. In such a case, the above problems may be dealt with by memories of developers if there is not much mutual independence between the combinations, but considering a case in which there is much mutual independence, and support, it seems to be important to record environments in which a computer is normally operated.

Conversely, even information on environments in which a computer are not normally operated is important, comparisons between information on computers which are normally operated, and that on computers which are not normally operated make the mutual interdependence clear, and developers of software can deal with a problem that computers are not normally operated. Also, there is not only a case in which the developer of the software deals with the problem and a case which the side of a support center deals with the problem, but also other cases. When it is easy to obtain necessary information, users of software can check faults for themselves to follow up the causes of the faults or to manage changes in operating environments.

However, since information has been conventionally collected, noticing only on a point when faults occur, as described in the non-patent document 1, and in the patent documents 1 and 2, it is thought to be difficult to diagnose faults caused by differences between operating environments as information on environments in which computers are normally operated, and the like may not be understood. In addition, when statuses of faults which occur in general-purpose computers are diagnosed, it is effective to diagnose the statuses from contents displayed on display screens, but there have been no methods in which the contents displayed on the display screens are collected. Therefore, it is thought that processing such as confirmation of displayed contents by telephone is required according to cases.

Also, it is important that a piece of application software is shipped after sufficient verification of the software in order to prevent occurrence of faults when the application software operating on a general-purpose computer is provided. When a piece of application software which is used by a general user is developed and maintained, consideration for differences in the operating environments of application software, such as consistency between a basic software and the version, and consistency between the kind of hardware and the driver, is required, and it becomes important to confirm under what kind of an operating environment the verification of the software is executed, but it has been difficult to execute verification of software which depends on operating environments as there is no method by which the operating environment is easily understood. Therefore, there have been many cases in which faults in software often occur due to miss in tests at provision or at version up of software. Also, even computer managers can not exactly manage the operating environments of each computer in a corporation and the like under the present situation, as it is difficult to precisely understand the operating environments of each computer including differences in hardware configurations and kinds or versions of software configurations in general-purpose computers which individuals use. Therefore, simple faults tend to occur when number of hardware devices is increased, or when a general-purpose computer is replaced.

The present invention has been made considering the above circumstances, and the object of the present invention is to provide a tool and a system for software verification support which can collectively collect information effective for verification of software operations such as understanding of operating environments of software, following up of fault causes, and verification of normal operations by one-touch operation or by a command from a program, and by which it can become easier to execute diagnosis of various kinds of faults generated on a computer and management of a computer configuration, and it is possible to prevent faults in software due to operating environments.

The present invention relates to a tool and system for software verification support which mainly supports verification of software operations including understanding of operating environments of software which operates on a computer, following up of fault causes, and verification of normal operations. With regard to the tool for software verification support, the above object is realized by comprising: system information acquisition means which is started by an instruction of a user or a command from a program, acquires information in a hard copy of a display screen displayed at least at the starting time as system information of the relevant computer necessary for the software-operation verification, and describes computer information related with software operations including software operating environments at the starting time in a text format and acquires the computer information; system information preservation means which preserves the acquired system information in a piece of recording media which the computer can read; and system information output means which outputs the acquired system information in a predetermined format which the computer and the relevant user can recognize.

Moreover, the above object is more effectively achieved by further comprising: electronic-mail automatic transmitting means which automatically generates an electronic mail which has the information in a hard copy of a display screen as an attachment file and the computer information as a text, and which automatically transmits the electronic mail to a relevant address; that the starting is executed by an instruction through one operation of a user, and a series of processes from acquisition of the system information by the system information acquisition means to generation and transmission of the electronic mail by the electronic-mail automatic transmitting means are automatically executed; and that the system information output means comprises at least any one of the following functions: a function which recognizably outputs a collation result between the system information at normal operation and the system information at not-normal operation for the same computer, based on accumulation information of the system information which has been preserved in the recording media; a function which recognizably outputs a collation result with the system information collected in a different kind of computer; and a function which recognizably outputs changes in the operating environment of the relevant software.

Furthermore, the above object is more effectively achieved by: that the system information acquisition means acquires as an element of the computer information table information on pieces of operating software, which can specify any one of pieces of application software which have been simultaneously operated at the stating time; that the system information acquisition means acquires as an element of the computer information table information on pieces of installed software, which can specify any one of pieces of application software which have been installed in the computer; that the system information acquisition means acquires as an element of the computer information on a relevant file including version information of an arbitrary file specified by a user; and that the software to be verified is a piece of application software, and the system information acquisition means acquires information for following up faults, which has been set according to a relevant application software as one element of the computer information.

In addition, the above object is more effectively achieved by: that a file which is arbitrarily specified by a user, other than the information in a hard copy of the display screen and the computer information, may be set as a file to be acquired as the system information; that the computer information comprises at least: computer identification information for specifying a computer which has acquired the system information; information on date/time when the system information was acquired, a hardware configuration of the relevant computer; a use state of hardware resources at the starting time; a table of pieces of application software which have been installed in the relevant computer, and a table of pieces of application software which are operating at the starting time, and the system information acquisition means collectively acquires the pieces of information; the electronic mail automatic transmission means attaches a relevant file as an attachment file of the electronic mail when the predetermined file is specified as a file to be acquired as the system information; that addresses of the electronic mail, and information to be transmitted can be arbitrarily set, and the relevant information may be transmitted to a plurality of addresses; that the tool for software verification support is a program by which the computer functions as the system information acquisition means, the system information preservation means, and system information output means; and that the tool for software verification support is a program by which the computer functions as the system information acquisition means, the system information preservation means, the system information output means, and the electronic mail automatic transmission means.

And, with regard to the system for software verification support, the above object is achieved by comprising: a user computer in which the tool for software verification support is installed; and a computer for fault-clearing support having system information receiving means which receives the electronic mail from the user computer, and fault-dealing information transmitting means which replies a diagnosis result of a relevant computer, which is made based on system information included in the electronic mail, to the user computer as a text or an attachment file of an electronic mail.

### BRIEF DESCRIPTION OF THE DRAWINGS

FIG. 1 shows an exemplary view of one example of whole system configurations according to the present invention;

FIG. 2 shows a block diagram of one example of configurations for principal parts of the tool for software verification support according to the present invention;

FIG. 3 shows a block diagram of one example of configurations of a computer for fault-clearing support according to the present invention;

FIG. 4 is an explanatory flow chart of one example of basic operations of a client in which a tool for software verification support according to the present invention is installed;

FIG. 5 is an explanatory view of one example of stating forms of collecting/transmitting operations of system information according to the present invention;

FIG. 6 is an explanatory flow chart of one detailed example of operations of a client in which the tool for software verification support according to the present invention is installed;

FIG. 7 is a first serial view of FIG. 6;

FIG. 8 is a second serial view of FIG. 6;

FIG. 9 is a view showing one example of information which is transmitted as a text of an electronic mail for following-up of faults; and

FIG. 10 is a first serial view of FIG. 9.

### DETAILED DESCRIPTION OF PREFERRED EMBODIMENTS

An object of a tool for software verification support according to the present invention is to be used by a user or a support center as a support tool for clearing faults, including for following-up of the causes of faults, and an emergency measure when the faults occur in software, and another object is to be used in a various manner, for example, for verification of normal operations under various kinds of operating environments at software development, and for management of computer configurations (management of hardware configurations, software configurations, network configurations, versions, and the like). The tool has main functions comprising: a function by which image information in hard copies of display screens and computer information on software operation such as software operating environments are collectively acquired; a function by which the acquired information is preserved in a piece of recording media; and a function by which the acquired information is output in a predetermined format. Output forms includes: an output form by which the acquired information is automatically output to a relevant address (a third party address such as a support center) by electronic mail, and another output form of a self-contained type by which the acquired information is output on a piece of display media such as a display screen and on a piece of printed media in order to allow self confirmation.

In the output form to a third party address, a function, by which system information including information for following-up of faults, which is required for clearing of the faults, is mechanically collected and is transmitted to a relevant address by electronic mail, is provided so that a relevant software developer and the like may obtain every information required for following-up of the causes of problems, and the side of a support center may quickly deal with the problems for a relevant user, for example, when there are various kinds of problems in software. In the present embodiment, the tool for software verification support is a piece of software comprising programs to execute the tool in a computer, and is applied to various kinds of information processing devices, which can execute and control computer programs, such as personal computers of general users, computers for development, business computers, and various kinds of servers. Moreover, the present invention includes a method using the tool for software verification support, and a computer system which utilizes information from the tool.

Hereinafter, preferable embodiments according to the present invention will be explained in detail, referring to drawings.

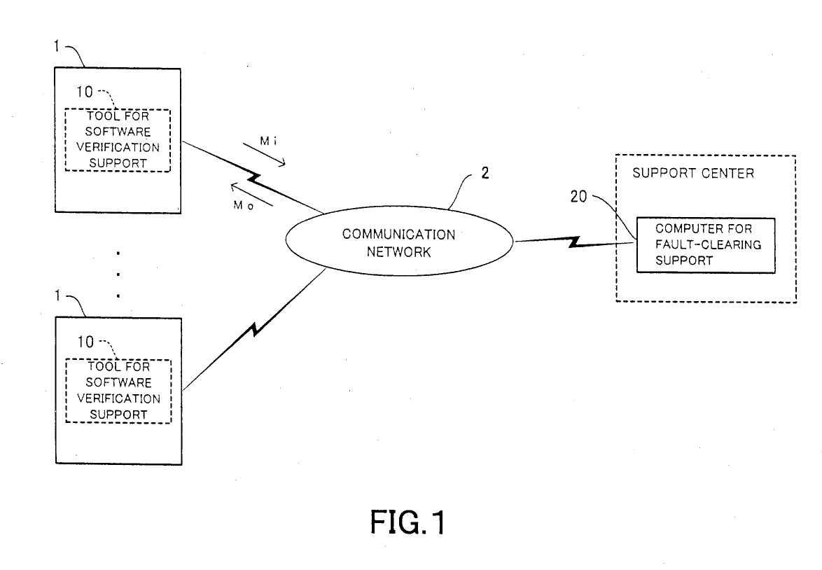

FIG. 1 shows an exemplary view of one example of whole system configurations according to the present invention, wherein each user computer 1 (hereinafter called “client”) such as a personal computer is connected at an appropriate time to a computer 20 for fault-clearing support through a communication network 2 such as the Internet. A tool 10 for software verification support is installed in the client 1, automatically collects information (hereinafter called “system information”) required for following-up of the causes of faults and the like generated in software which is operated on the client 1 and transmits a relevant electronic mail Mi, which has the information as a text or an attachment file, to the side of the support center (a mail server, the computer 20 for fault-clearing support in the present example). The side of the support center analyzes the faults, based on the system information included in the electronic mail, and returns information for clearing the faults and software for dealing with the faults, or any one of them to the client 1 of the transmission source as an electronic mail Mo. And, in the output form of a self-contained type, the collected system information is output in a predetermined format which can be recognized by the computer and the relevant user. An output destination is a piece of media, such as a display device and a printer, which is connected to the relevant computer and visibly displays the system information. Furthermore, the collected system information is preserved in a media, which can be read by the computer, so that retrieval can be executed with a predetermined key.

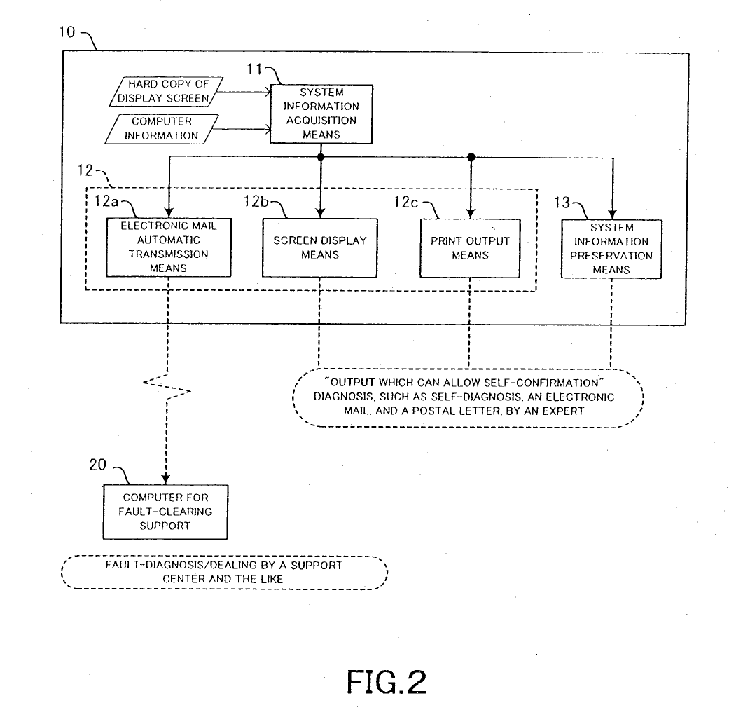

FIG. 2 shows a block diagram of one example of configurations for principal parts of the tool for software verification support according to the present invention. The tool 10 for software verification support comprises: system information acquisition means 11 which acquires, based on stored information in the client 1, information in a hard copy of the display screen of the display device as system information, which is required for software verification, of the relevant computer; and computer information, including software operating environments, on software operation after the computer information is described in a text format; system information output means 12 which outputs the acquired system information in a predetermined format which can be recognized by the computer and the relevant user; and system information preservation means 13 which preserves the acquired system information in the recording media.

In the present embodiment, the system information is collected when a user instruction or a command from a program is received. The system information to be collected is roughly divided into the following three groups: (1) information in a hard copy of a display screen (image data on a display screen); (2) computer information on software operation such as static operating environments and dynamically-changing operating environments; and (3) a file which is arbitrarily specified by a user. The recording media in which the acquired system information is preserved is a media, which can be read by the computer, such as a flexible disk, a hard disk, a CD-ROM (compact disc read-only memory), a CD-R (compact disk recordable), a DVD-ROM (digital video disk read-only memory), a DVD-RAM (digital video disc random access memory), a DVD-R (digital video disk recordable), a PD disk (phase change optical disk), an MD disk (magnetic disk), an MO disk (magneto optical disk), an memory card, and an IC card, but the kind and the existing location of the media are not limited if input/output control of the media can be executed by a CPU.

The system information output means 12 functionally comprises, for example, as shown in FIG. 2: electronic-mail automatic transmitting means 12a; screen display means 12b; and print output means 12c. The screen display means 12b and the print output means 12c are means which display image information in a hard copy of a display screen or text information of the computer and output the information as a print. Thereby, the above means allow diagnosis by users themselves or experts. For example, when a user has a predetermined level of experience and checks for a fault displayed on a display screen or for the printed fault, the user can be asked to confirm the fault singly and to locate the cause of the fault. The electronic-mail automatic transmitting means 12a has a function by which an electronic mail having, an attachment file, the information in the hard copy of a display screen and including, as a text, computer information described according to the text format, is automatically generated and is transmitted to a relevant address. Furthermore, there is provided one function by which, when a predetermined file (a file which is arbitrarily set by a user of the present tool, including a developer of the software) is set as system information to be acquired, the relevant file is automatically attached as an attachment file of an electronic mail and is transmitted. Information to be acquired can be selected by a command of a user or a program, and, with regard to information to be transmitted, the acquired information can be also selected for transmission. Here, though the computer information described according to the text format is configured to be transmitted as a text of an electronic mail in this example, one form by which the computer information is transmitted as an attachment file may be adopted.

In the present invention, in order to collect information by a simple operation as required, and to quickly deal with some fault when a fault occurs in software operating on a client, processing of information collection is started by a starting instruction, for example, through one-touch operation by a user, or a starting command from fault detection means, and, then, a series of processes from collection of system information, to generation and transmission of an electronic mail, are configured to be executed by the tool 10 for software verification support. The above-described fault detection means indicates a detection function of a fault including a logical error which is detected by software itself with something wrong, or a detection function of a fault which other pieces of software or those of hardware have. When a fault is detected, a relevant process of the tool 10 for software verification support is automatically started. The starting command may be arbitrarily issued not only from the fault detection means, but also from an arbitrary program such as a utility program for configuration management and general application software regardless of the presence of a fault. Moreover, the tool 10 for software verification support itself may regularly acquire the system information at specified intervals and the like, or may acquire, based on purposes, information which is set to be acquired according to usage.

Here, though the tool 10 for software verification support is formed by software which independently operates as a separate task from various kinds of application software, information on the provider of the above tool, such as a provider name and a product name, which is displayed on the display device, is configured to be arbitrarily set so that the tool 10 can be provided as a support tool for a specific application software. Moreover, an address to which the system information is transmitted, and an operation form of the system information and the like to be transmitted, other than the above information on the provider, are also configured to be arbitrarily set by a user. For example, when there are a plurality of pieces of software which are related with a fault, and a plurality of addresses to which system information is transmitted, the relevant system information is configured to be transmitted to the plurality of the addresses by repeating the following steps: (a) transmission to the relevant address by a starting instruction; and (b) change operation of the address and the like.

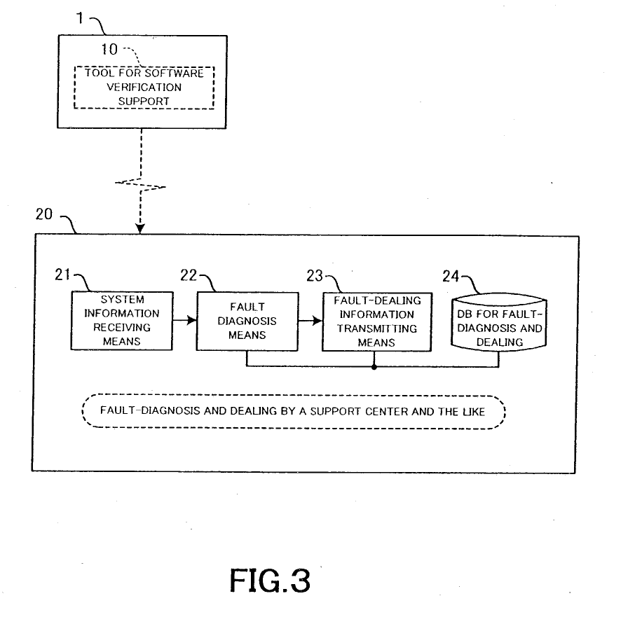

FIG. 3 shows one example of configurations of the computer 20 for fault-clearing support. The computer 20 for fault-clearing support comprises one or a plurality of computers with functions such as a receive mail server; a send mail server; a database server having accumulation information for fault-clearing, and the like; a web server; and a computer for fault-analysis. Principal means of the computer 20 are: system information receiving means 21 which receives the above electronic mail from the client 1; fault diagnosis means 22 which makes a diagnosis of faults of the relevant computer, based on the system information included in the relevant electronic mail (information for fault following-up in this example) and information in the data base 24 for fault diagnosis and dealing, and draws a required diagnosis result; fault-dealing information transmitting means 23 which replies the drawn diagnosis result (a fault cause, information for clearing the fault, software dealing with the fault, and the like) to the client 1 as a text or an attachment file of an electronic mail; and a data base 24 for fault diagnosis and dealing which stores fault-dealing procedures for each fault, fault-dealing software such as a correction program, a diagnosis program and the like. It is possible to automate some parts of functions in the computer 20 for fault-clearing support. For example, when the fault diagnosis means 22 is provided with a function for fault-cause analysis, and the fault-cause is automatically analyzed from an error message included in the system information, pieces of version information of each software and the like, an answering electronic mail which has information or software for clearing the relevant fault as a text or an attachment file of the electronic mail is made and automatically transmitted.

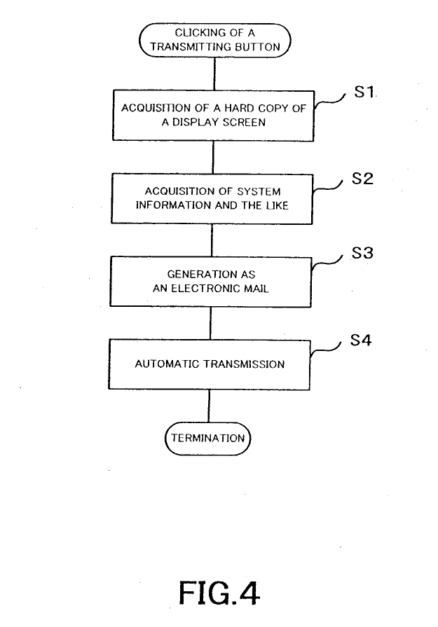

Based on the above configuration, one example of basic operations of the client 1, in which the tool 10 for software verification support is installed, will be explained along a flow in a flow chart shown in FIG. 4. Here, a case, in which the system information (here called “information for fault following-up” for convenience) is automatically transmitted to the computer 20 for fault-clearing support in the support center, using the electronic-mail automatic transmitting means 12a, will be described as one example.

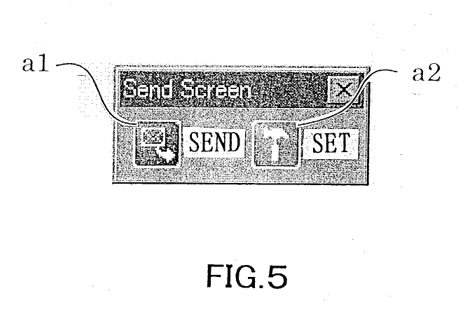

In a standby state of the tool 10 for software verification support, an operation window for a send button a1, and a set button a2 is displayed on the display screen of the client 1, for example, as shown in FIG. 5. Usually, when the send button a1 is pushed down (clicking operation), a hard copy of the display screen is acquired (STEP S1); computer information including software operating environments is acquired after the computer information is described in a text format; a file set as a specified file to be acquired is acquired (STEP S2); the acquired file is made into an electronic mail (STEP S3); the above electronic mail is automatically transmitted to a specified address which is set beforehand, using an SMTP (Simple Mail Transfer Protocol) which is an Internet mail sending protocol (STEP S4); and processing for collection and transmission of the system information terminates. That is, the user may transmit information necessary for the support to the support center by a one-operation instruction (one clicking). When the above tool 10 for software verification support is built in, for example, on an OEM (Original Equipment Manufacturing) basis, a series of processes from collection of the system information, to generation and transmission of an electronic mail may be also configured to be started not by pressing down the send button a1, but also by a command from the built-in application software, and to be executed in an automatic manner.

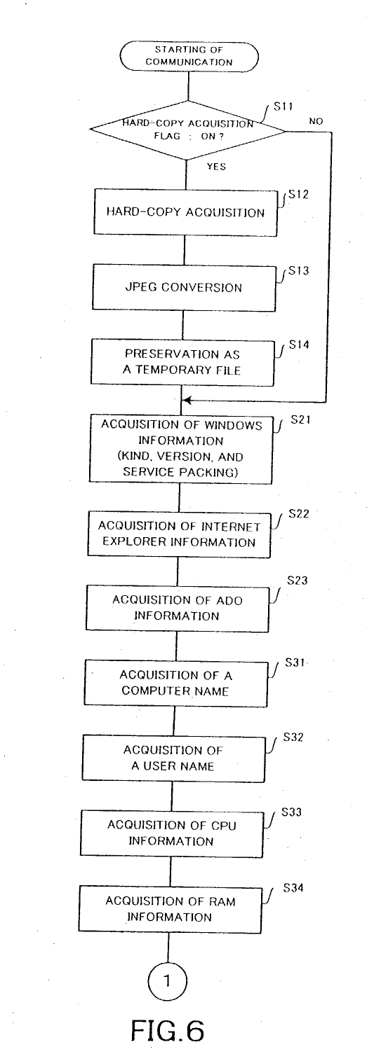

Subsequently, referring to one concrete example of the system information which the system information acquisition means 11 collects, one example of operations will be explained in detail along a flow in flow charts shown in FIG. 6 through FIG. 8. Here, the processing order of processes is not limited to the order in the present example, but the present invention includes other forms in which the processes are simultaneously executed. Moreover, though a case in which an electronic mail is automatically transmitted will be explained as one example in this example, basic operations are similarly executed even in a form (self-contained type form) in which an electronic mail is not automatically transmitted, but only a point that the processing related with the transmission of an electronic mail is not executed is different from this example.

In the first place, the tool 10 for software verification support checks whether a hard copy acquisition flag is ON or not, after receiving an instruction from a user, or a command from a program such as an application software (STEP S11). In the case of ON, information in “a hard copy of a display screen” of the client 1 is acquired in order to recognize what kind of an error message is displayed on the display screen at generation of a fault, or what kind of operation is being executed (STEP S12), and the information is preserved as a temporary file after conversion into a general-purpose file format (for example, JPEG) (STEP S13 and STEP S14). Subsequently, computer information related with software operation is described in the text format and is acquired. First of all, information on basic software (information on the kind, version, and service packing of Windows, which is an operating system by Microsoft USA Corporation, and the like in the present example), information on a browser (information on the version of Internet Explorer by Microsoft USA Corporation, and the like in the present example), access information used for data access to a relational data base, electronic mails and the like (information on the version of ADO (ActiveX Data Objects by Microsoft USA Corporation, and the like in the present example), and the like are independently acquired as “basic system information” indicating what kind of system the client 1 is (STEP S21 to S23).

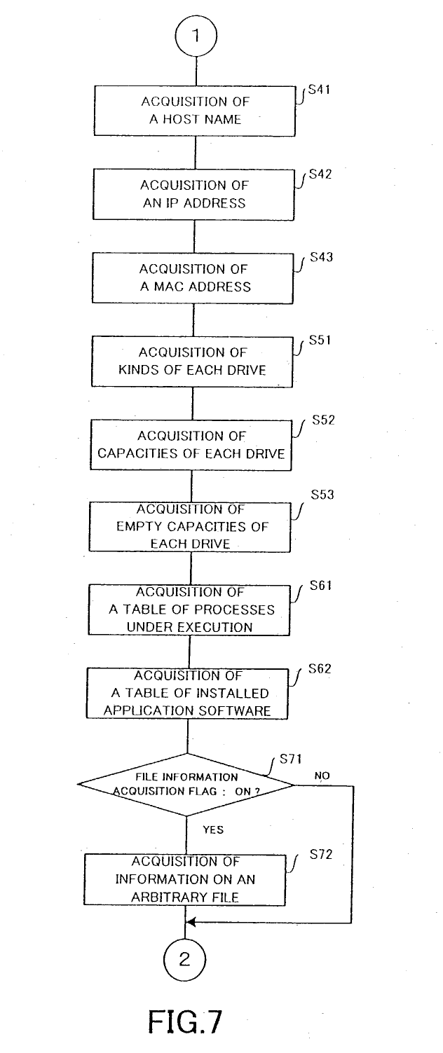

Moreover, the name of a computer, the name of a user, CPU information (a vender name, a model type, and a clock cycle of the CPU), RAM information (memory capacity, and the like), display information (resolution, number of colors, and the like), information on peripheral devices such as printer information (the model type of an installed printer, and the like), and the like are independently acquired as “hardware information” of the client 1 (STEP S31 to S34). Furthermore, information on a host name, Internet Protocol addresses which are an address specifying a communication end, MAC addresses (media access control addresses) which are physical addresses peculiar to network devices and the like are independently acquired as “network information” of the client 1 (STEP S41 to S43 in FIG. 7). In addition, information on effective drives, the kinds of each drive, the capacities of each drive, and the current empty capacities of each drive and the like are independently acquired as “drive information” to recognize whether there is enough empty capacity to execute the system or not? (STEP S51 to S53).

And, information on pieces of application software under operation are collected as “information of processes under execution” for table information listing pieces of operating software (STEP S61) in order to specify pieces of application software, other than application software with something wrong, which are simultaneously operated (parallel operation). In addition, in order to recognize the existence of conflicts between pieces of software, or, to manage the configuration of pieces of software, table information on the installed pieces of software, which indicates that what kinds of application software have been installed, is acquired. Thereby, information on versions of pieces of software and the like may be confirmed (STEP S62).

Subsequently, it is checked whether the file acquisition information flag is ON or not (STEP S71), and, in the case of ON, information on the version of the relevant file, the time stamp, the file size, information on OLE (also called Object Linking and Embedding: OCX), which indicates linking and embedding states of objects, and the like, information on dynamic link library (DLL: Dynamic Link Library), and the like are independently acquired as “file information”. A plurality of files can be arbitrarily set as a file, for which file information is required to be acquired, by specification of a user (including the developer and the provider of this tool), and may be also specified at transmission by operation of the set button a2 shown in FIG. 5. Moreover, for example, when files are provided as a utility program of pieces of application software, for example, related files of the relevant application software may be set beforehand (STEP S72).

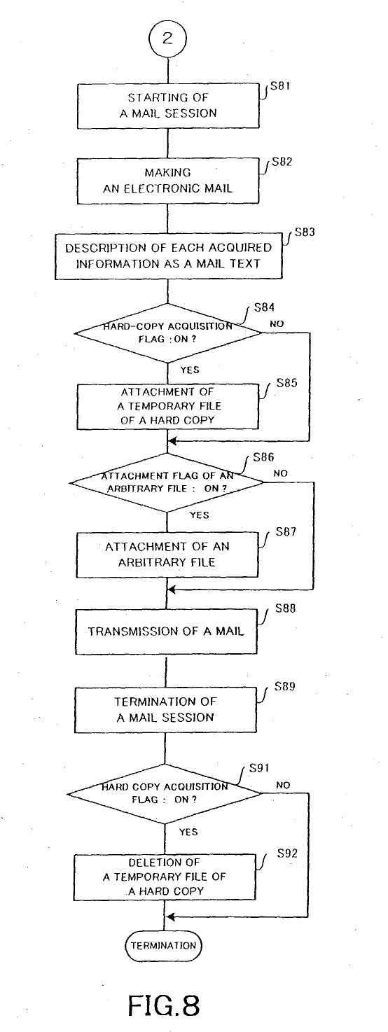

Subsequently, a mail session is started (STEP S81 in FIG. 8), and an electronic mail which has collected information for following-up of the fault as a text or as an attachment file is generated (STEP S82). In this example, information other than that in a hard copy of a display screen is described as a mail text (STEP S83), and, when the hard copy acquisition flag is ON, a file of the hard copy of the display screen temporarily preserved at STEP S14 is attached as an attachment file of an electronic mail (STEP S84 and S85). Subsequently, it is checked whether an attachment flag of an arbitrary file is ON or not (STEP S86), and, in the case of ON, the arbitrary file is attached to the electronic mail. The above-described arbitrary file is a file which is arbitrarily set by a user (including the provider of the above tool), and a plurality of files may be attached. In the same manner as that of the file information, the files are also configured to be specified by operation of the set button a2 in FIG. 5 at transmission (STEP S87).

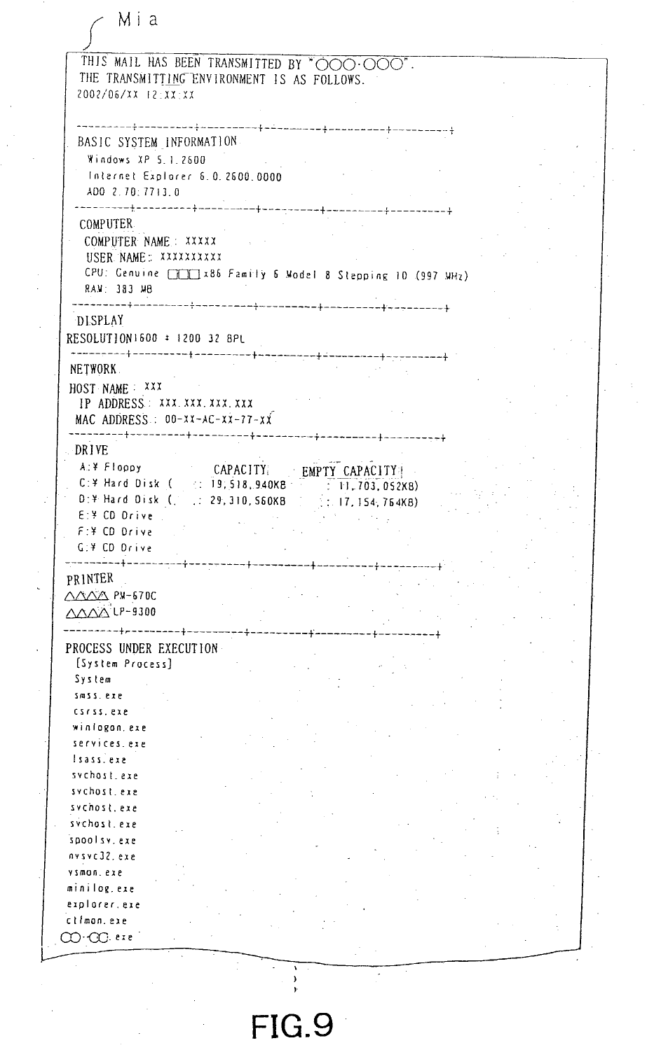

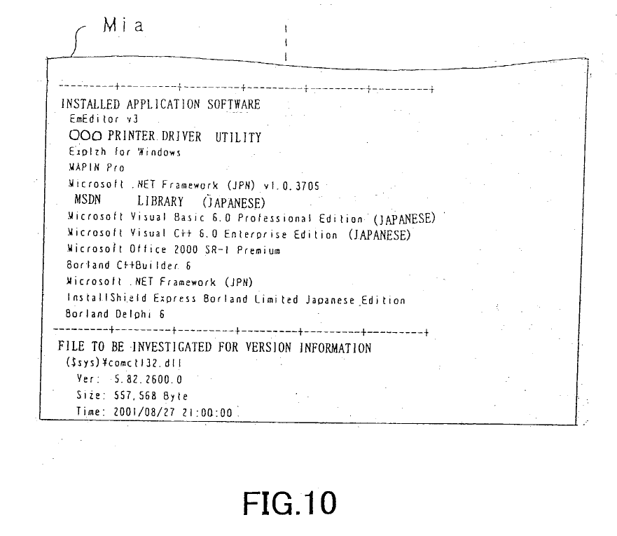

When the above electronic-mail generation processing terminates, for example, an electronic mail which has information Mia as a text as shown in FIG. 9 and FIG. 10 is transmitted to the relevant address (STEP S88). Then, when the mail session terminates (STEP S89), and the hard copy acquisition flag is ON, the temporary file of a hard copy is deleted (STEP S91 and STEP S92), and every processing terminates. Here, the acquired system information is configured to be preserved in the recording media, and to be appropriately used by the relevant computer or other computers.

Then, other use forms of the acquired system information will be explained. The system information preserved by the system information preservation means 13 may be effectively used not only by a general user, but also by a computer manager and a software developer. The system information may be used for following-up of faults as described above, and, moreover, it may be used for various kinds of usage, for example, for understanding of software operating environments under regular operation, for software operation verification under each operating environments at software development and maintenance, configuration management of the hardware and the software, and the like. For example, the above-described system information output means 12 comprises: a function by which system information at normal operation and the system information at not-normal operation are collated for the same computer, based on the accumulation information on the system information preserved in the recording media, and the collation result is output in a recognizable manner; and a function by which the collation result obtained by collation of pieces of the system information with those collected in another kind of computer is recognizably output. By use of the above functions, verification of faults in the relevant software, verification of normal operation, and operation verification under various kinds of operating environments may be executed. And, when a function by which changes in the operating environment of the relevant software for a predetermined period are output in a recognizable manner, based on accumulation information on system information preserved in the recording media, is provided, various kinds of information such as what kinds of hardware have been added; when the hardware were added; whether correction codes suitable for the relevant versions have been applied in pieces of basic software and application one which have been currently used; whether the occurred fault is due to the operating environment; whether pieces of application software required for a case in which computers are added in firms and the like have been installed; and the like may be easily obtained.

Here, though cases in which one tool for software verification support is operated have been explained as one example in the above-described embodiments, the relevant information for following faults, which has been set for the relevant application software, (file information which the relevant application software uses, and the like) may be configured to be acquired and to be transmitted to the relevant address in an automatic manner by operating a plurality of tools (or by control of one tool) when a fault is generated in the relevant application software. Moreover, though cases in which verification of application software is operated have been explained as one example in the above-described embodiments, the system information may be also applied for verification of the basic software and the middleware.

Since, as explained above, information in a hard copy of a display screen effective for following-up of faults in software or for verification of normal operation, and computer information related with software operation are collectively collected as system information and are output by an instruction of a user or by a command from a program in a predetermined format which a computer and the relevant user can recognize according to the present invention, a work load of information collection may be reduced, and it may become easier to clear the faults in software, to verify normal operation, and to manage a computer configuration. Moreover, since the computer information is configured to be described in the text format for acquisition, the contents of the information may be recognized without using special software, and the information may be fully utilized, using other pieces of software.

Furthermore, since information indicating computer environments not only for operation with faults, but also for normal operation is configured to be preserved, and pieces of system information are configured to be compared with each other, the information may be used for various kinds of usage such as determination whether occurred faults are due to operating environments, and management of histories of software and hardware configuration. In addition, since a user may set information on an arbitrary file, or the file itself as a file to be acquired, the invention may be fully used as a general-purpose tool.

Furthermore, since a function by which acquired system information is automatically transmitted as an electronic mail is provided, information necessary for dealing with or clearing faults in software may be automatically acquired and quickly conveyed to the side of a support center, even if operating environments of a computer which a user is using are not checked. And, since the most effective information in the past, including information in a hard copy of a display screen, is configured to be transmitted, it becomes easier to follow up faults at the side of a support center, and it may be possible to remarkably reduce time which is required at the side of the support center for dealing with the faults. Thereby, services for users can be greatly improved, and personnel expenses can be saved.

What is claimed is:

1. A tool for software verification support which mainly supports verification of software operations including understanding of operating environments of software which operates on a computer, comprising:
system information acquisition means which is started by an instruction of a user or a command from a program, acquires information in a hard copy of a display screen displayed at least at the starting time as system information of the relevant computer necessary for the software-operation verification, and describes computer information related with software operations including software operating environments at the starting time in a text format and acquires the computer information;
system information preservation means which preserves the acquired system information in a piece of recording media which the computer can read; and
system information output means which outputs the acquired system information in a predetermined format which the computer and the relevant user can recognize.

2. The tool for software verification support according to claim 1, further comprising:
electronic-mail automatic transmitting means which automatically generates an electronic mail which has the information in a hard copy of a display screen as an attachment file and the computer information as a text, and which automatically transmits the electronic mail to a relevant address.

3. The tool for software verification support according to claim 2, wherein
the starting is executed by an instruction through one operation of a user, and a series of processes from acquisition of the system information by the system information acquisition means to generation and transmission of the electronic mail by the electronic-mail automatic transmitting means are automatically executed.

4. The tool for software verification support according to claim 1, wherein
the system information output means comprises at least any one of the following functions:
a function which recognizably outputs a collation result between the system information at normal operation and the system information at not-normal operation for the same computer, based on accumulation information of the system information which has been preserved in the recording media;
a function which recognizably outputs a collation result with the system information collected in a different kind of computer; and
a function which recognizably outputs changes in the operating environment of the relevant software.

5. The tool for software verification support according to claim 1, wherein
the system information acquisition means acquires as an element of the computer information table information on pieces of operating software, which can specify any one of pieces of application software which have been simultaneously operated at the stating time.

6. The tool for software verification support according to claim 1, wherein
the system information acquisition means acquires as an element of the computer information table information on pieces of installed software, which can specify any one of pieces of application software which have been installed in the computer.

7. The tool for software verification support according to claim 1, wherein
the system information acquisition means acquires as an element of the computer information on a relevant file including version information of an arbitrary file specified by a user.

8. The tool for software verification support according to claim 1, wherein
the software to be verified is a piece of application software, and
the system information acquisition means acquires information for following up faults, which has been set according to a relevant application software as one element of the computer information.

9. The tool for software verification support according to claim 1, wherein
a file which is arbitrarily specified by a user, other than the information in a hard copy of the display screen and the computer information, may be set as a file to be acquired as the system information.

10. The tool for software verification support according to claim 1, wherein
the computer information comprises at least: computer identification information for specifying a computer which has acquired the system information; information on date/time when the system information was acquired, a hardware configuration of the relevant computer; a use state of hardware resources at the starting time; a table of pieces of application software which have been installed in the relevant computer, and a table of pieces of application software which are operating at the starting time, and
the system information acquisition means collectively acquires the pieces of information.

11. The tool for software verification support according to claim 2, wherein
the starting is executed by the command from the program, and
a series of processes from acquisition of the system information by the system information acquisition means, to generation and transmission of the electronic mail by the electronic mail automatic transmitting means are automatically executed.

12. The tool for software verification support according to claim 2, wherein
the electronic mail automatic transmission means attaches a relevant file as an attachment file of the electronic mail when the predetermined file is specified as a file to be acquired as the system information.

13. The tool for software verification support according to claim 2, wherein
addresses of the electronic mail, and information to be transmitted can be arbitrarily set, and
the relevant information may be transmitted to a plurality of addresses.

14. The tool for software verification support according to claim 1, wherein
the tool for software verification support is a program by which the computer functions as the system information acquisition means, the system information preservation means, and system information output means.

15. The tool for software verification support according to claim 2, wherein
the tool for software verification support is a program by which the computer functions as the system information acquisition means, the system information preservation means, the system information output means, and the electronic mail automatic transmission means.

16. System for software-fault clearing support, comprising:
a user computer in which the tool for software verification support according to any one of claims 1 through 15 is installed; and
a computer for fault-clearing support having system information receiving means which receives the electronic mail from the user computer, and fault-dealing information transmitting means which replies a diagnosis result of a relevant computer, which is made based on system information included in the electronic mail, to the user computer as a text or an attachment file of an electronic mail.
